(19) United States
(12) Patent Application Publication
(10) Pub. No.: US 2025/0148002 A1
(43) Pub. Date: May 8, 2025

(54) LINKING UNCOORDINATED MEDIA FOR COORDINATED VIEWING BASED ON MATCHING METADATA

(71) Applicant: Arenai, LLC, Newark, DE (US)

(72) Inventors: Basem Salloum, Newark, DE (US); Michael Joseph Karlin, Bethesda, MD (US)

(21) Appl. No.: 18/936,642

(22) Filed: Nov. 4, 2024

Related U.S. Application Data
(60) Provisional application No. 63/547,264, filed on Nov. 3, 2023.

(51) Int. Cl. G06F 16/438

(52) U.S. Cl. CPC G06F 16/438

(57) ABSTRACT

A media search system is described here that finds existing media based on matching metadata and links them together for orderly viewing. The system uses social media providers and artificial intelligence and/or machine learning and or other public APIs to search available metadata of media stored by each provider to find matching metadata for what a person is looking for in a specified area. The system may apply artificial intelligence (AI) to generate additional criteria to use for the search to find media responsive to the person's request. The system then groups the discovered media according to the found metadata and AI may also contribute suggestions for organizing the discovered media. Once the media is grouped together, the system allows the user to switch between media within the same group. Thus, the media search system makes the wealth of available media more accessible to people looking for a particular event.

### CROSS-REFERENCE TO RELATED APPLICATIONS

The present application claims the benefit of U.S. Patent Application No. 63/547,264 (Attorney Docket No. ARENAI001) entitled “LINKING UNCOORDINATED VIDEOS FOR COORDINATED VIEWING BASED ON MATCHING METADATA,” and filed on 2023 Nov. 3, which is hereby incorporated by reference.

### BACKGROUND

The world is filled with media being created every day. Media can include photos, videos, animations, three-dimensional (3D) content, content captured with sensors (such as LIDAR), and so forth. Photos and videos may be of the physical world, such as photos or videos taken with a smartphone camera or single-lens reflex (SLR) camera or created of a virtual world, such as photos, videos, and metaverse media made with software. Metaverse media may include 3D renderings such as extended reality (XR), mixed reality (MR), augmented reality (AR), or virtual reality (VR) images and videos.

Most media created today has one or more forms of metadata. Metadata is data that describes data and in general stores useful related properties of the media. For example, a photo taken with a smartphone has metadata that describes the time the photo was taken, the global positioning system (GPS) location reported by the smartphone where the photo was taken, what resolution was used, camera settings (e.g., focal length, flash on/off, and so on), and potentially even faces recognized or other advanced data provided by analysis of software on the device that captured the photo. Comparable properties are captured for videos, such as time recorded, location/venue, name of the event, length of video, video settings, and so forth.

Today, many photos and videos are made public or semi-public (shared with friends or other groups) on social media services such as Facebook, Instagram, Snapchat, TikTok, X (formerly Twitter), etc. These types of media can be accessed by using the social media provider through dedicated software applications or websites. Many social media providers also publish developer application programming interfaces (APIs) that can be used to access data of the social media provider programmatically. This media is often made public by individuals with no known connection to each other, and may be live, recorded, or a combination.

Although there is a wealth of media being created in the world today, it is often difficult for a user to access the media that they want at the time they want to view it. For example, it can be challenging to find media of particular events on social media sites. A user might spend hours looking at dozens of users' videos of an event, such as a wedding, to find what the user is looking for. Although a user might attend an event and create their own media of the event, the user might later wish they had captured another angle or used more flash. The user may also want a more complete viewing of the event. The user is then left to search through a seemingly endless amount of publicly available media to find what the user is looking for.

### BRIEF DESCRIPTION OF THE DRAWINGS

FIG. 1 is a block diagram that illustrates components of the media search system, in one embodiment.

FIG. 2 is a flow diagram that illustrates processing of the media search system to crawl for relevant media, in one embodiment.

FIG. 3 is a flow diagram that illustrates processing of the media search system to find media related to a user search, in one embodiment.

### DETAILED DESCRIPTION

A media search system is described here that finds existing media based on related metadata and links them for orderly viewing. A person who attends an event or misses attending an event can employ the media search system to find media related to that event. The person might know the name of the event, a particular geographic location (e.g., the Statue of Liberty) where the event occurred, a time during or range within which the event occurred, and so forth.

The media search system uses social media provider APIs to search available metadata of media stored by each provider to find matching metadata for what the person is looking for. The system may apply artificial intelligence, machine learning, and similar methods to generate more criteria for the search to find media responsive to the person's request. If a particular event is requested, the system looks up the location of the event and scrapes/mines the internet to collect all publicly available media based on the location (using latitude and longitude, for example) or the event name. If a date and/or time is provided, the system may use that information to further refine the search.

The metadata can be accessed whether the media is still on the device that captured the media or is integrated with a platform that can organize such metadata. For example, Facebook, Instagram, Snapchat, TikTok, X, or any other media outlet that publishes public information also provides APIs that allow for searching and accessing this metadata.

The media search system then groups the discovered media according to some or all the found metadata (e.g., by location, chronology, and so on), and AI may also contribute suggestions for organizing the discovered media. The media can be grouped together, and the system allows the person to switch (e.g., via a swipe or click) between media within the same group. For example, the system may play a reel that summarizes each media item and allow the person to request to stop or view any particular item more fully. The media in the group are ordered in such a way to enable a person to methodologically switch from item to item within the group. Alternatively, the media can be presented as a group so the person can randomly select a particular item, or by a subgroup based on metadata. Grouping the media gives the person a unique experience of an event (whether the person was there or not) by searching and organizing relevant media from potentially millions of available media. Thus, the media search system makes the wealth of available media more accessible to people looking for a particular event.

The media search system saves users the headache of doing their own research and finding media everywhere. It would otherwise be difficult for users to find the necessary metadata and comb all the available media. They would find that some providers make this easy while others make it exceedingly difficult, and no two providers do so in the same way. The system then presents the found media in a useful way in which the user can find what the user wants among potentially vast amounts of information.

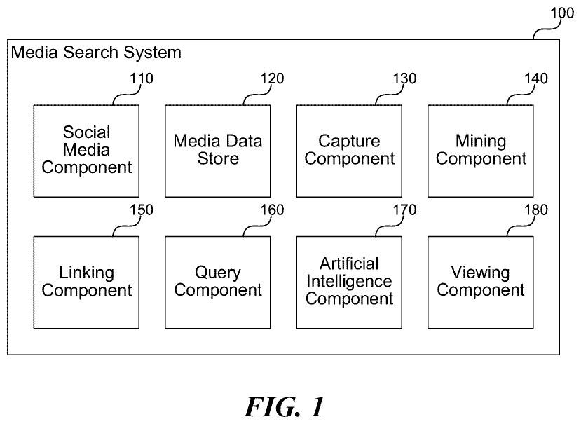

FIG. 1 is a block diagram that illustrates components of the media search system, in one embodiment. The system 100 includes a social media component 110, a media data store 120, a capture component 130, a mining component 140, a linking component 150, a query component 160, an artificial intelligence component 170, and a viewing component 180. Each of these components is described in further detail here.

The social media component 110 abstracts the differences of each social media provider's API to allow the media search system 100 to generically query for available media based on time and location from each social media provider. The social media component 110 may leverage a plugin architecture so that more social media providers can be added to the media search system 100 by writing a plugin specific to the new social media provider. Each plugin may expose a function to find new media since the last search and turn that into calls to the social media provider's API that conducts the request. The plugin may also expose functions for directly searching given a particular location (and distance from that location) or a particular time (and distance from that time).

The media data store 120 stores references to discovered media, a time associated with the discovered media, a location associated with the discovered media, and a preview of the discovered media. The preview may include a thumbnail or reel that will show the user what the discovered media depicts before the user accesses the full media from an original source. The media data store 120 may reference media from many different providers and sources and correlate the media by time, location, event, and other similarities. In some embodiments, the system 100 may recognize faces, landmarks, or other features in the media to correlate media by this information. The media data store 120 may reference media shared publicly on social media sites as well as media captured by the user so that each can be found in response to queries.

The capture component 130 captures the user's own media from a digital device of the user and stores metadata about the captured media so that the media can be included in future searches for the user. For example, if the user takes a photo or video with the user's smartphone, the capture component 130 receives the photo or video and adds additional metadata such as an event, location, or time to associate with the media, then stores that information in the media data store 120. The capture component 130 may operate on multiple digital devices of the user and send the media information to a central data store.

The mining component 140 collects and finds potentially relevant media by crawling various social media sites and other sources of publicly available media. Mining can occur in advance, via crawling, or on demand, such as via live search APIs or other methods. Crawling or scraping, is a method of accessing the Internet and other networks to collect media and metadata and everything that might be relevant, such as links to all available media and stores that information for later searching. Crawling or scraping generates an index that enables information retrieval along particular axes faster, such as media that occurred at a particular time or location. The time or location metadata can be indexed for fast lookup.

Live searching issues a query to a social media provider to find media that matches particular criteria as it is happening. Unlike crawling, live searching cannot spread out network demand and requires that the media providers be accessible at the time of the search (i.e., live searching cannot occur offline). However, live searching has the advantage of providing the most up-to-date response to a query, while crawling can only provide media known at the time of the last crawl.

The linking component 150 forms links between media references that identify media references that share common information, such as time or location. For example, a video taken by two different people at the same event would be linked together by location and time, indicating that they occurred at the same event. Subsequent queries for media from that event can use the links to find all of the relevant media responsive to the query. The linking component 150 may use database indexing or other methods to correlate data and make queries performant and fast.

The query component 160 receives queries from the user of the system 100. A query may include particular criteria that will match media the user wants to find, such as event name, location, time, or people involved. The query component 160 builds a query that asks either a previously built crawling index or a live search API of one or more media providers for media that matches the user's query. In some embodiments, the query is multi-staged, meaning that the user may make an initial query (“show me video of my cousin's wedding”), and then the system provides filtering criteria within the returned media so that the user makes further queries to refine the search (“show me videos from the left side of the banquet hall” or at a football game, “show me video from the 20 yard line”).

The artificial intelligence component 170 optionally augments the user's query with additional search criteria to help find relevant media. Artificial intelligence can use pattern matching and other methods to determine that particular words in the user's query imply other search terms that can help refine the query. Artificial intelligence can also be used by the query recipients to find relevant media in response to the user's query. Artificial intelligence may provide relevant information that the user forgot to provide or more detail than the user had time to type. Artificial intelligence works well as a supplement to the user's efforts to build additional query parameters that will help the user find the media that the user wants to find.

The viewing component 180 organizes returned media that matches the query and presents the returned media in a useful way for the user to find what the user is looking for. Depending on how much matching media is found, the system may summarize each media item (if a large number of media items are found) or present each item fully (if only a handful of items are found). The system may generate a collage that shows several media items at once, or a serial playback of many media items (e.g., a slideshow or reel). In some cases, the system may include stored profile and configuration information for each user of the system that determines how media is presented to each user based on each user's preferences.

The viewing component 180 may generate an interactive web page or provide a display through a mobile, web, desktop, or other dedicated application. Users can select events or click a certain location to see media elements grouped by the selected criteria. For locations, the viewing component 180 may show circles of media in a larger area and the user can click the circles to zoom into more refined sub-locations. For example, a city block may initially be shown that can then be refined to a particular stadium that can then be refined to a section of the stadium. Media at each of these locations can then be returned and refined until the user finds what the user is looking for.

The computing device on which the media search system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed here include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Program modules include routines, programs, objects, components, data structures, and so on that perform tasks or implement abstract data types. Typically, the functionality of the program modules may be combined or distributed as desired in various embodiments.

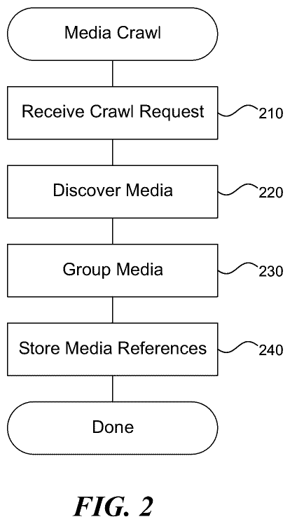

FIG. 2 is a flow diagram that illustrates processing of the media search system to crawl for relevant media, in one embodiment. Beginning in block 210, the system receives a crawl request to access publicly posted videos and stories by providing a specified handle of a third-party platform (i.e., Instagram, Snapchat, Facebook, etc.) and an interval (e.g., 24 hours) at which to crawl for new media. The system may have many such crawl requires open at a given time to crawl all of the known social media providers and other sources of media. In some embodiments, a backend system API connects to all the media sources to get media from certain handles based on handle username.

Continuing in block 220, the system looks up the current media showing on the handle's profile every specified interval (e.g., 24-hour period). In some embodiments, at time of initiation the discovery of media works immediately and then recurs every interval time period thereafter. The interval may be selected to coincide with the refresh of stories typically performed by users of social media platforms, such as daily every 24 hours. The system stores references to the discovered media with relevant metadata information, such as latitude and longitude of the media as well as a timestamp. The system may store this information for a set number of days in a media data store or indefinitely as long as storage is available to display the data for the user in response to queries.

Continuing in block 230, the system groups and organizes the discovered media according to media metadata to create media linking information. For example, the media metadata may include geographic location and time period, or any other combination of metadata can be used to decide which videos to group together. From the geolocation metadata specifically, the system can organize the media on a map in a trace style.

Continuing in block 240, the system stores references to the discovered media with the media linking information. The references may include a preview of the media, a uniform resource locator (URL) or other information where the full media can be accessed, a timestamp when the media was captured, a location where the media was captured, and an event that the media pertains to. The references may also include discovered information such as people identified in the media. After block 240 these steps conclude.

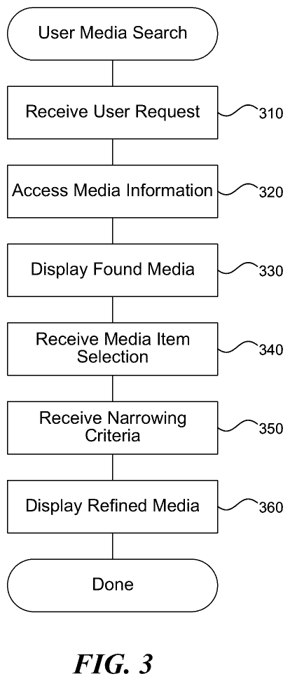

FIG. 3 is a flow diagram that illustrates processing of the media search system to find media related to a user search, in one embodiment. Beginning in block 310, the system receives a user request to find media that corresponds to a given event. The given event may be specified by time period, location, or other criteria. For example, if the user attended a wedding last week, the user may request to find media captured by other people at the location of the wedding on the same day. The user may later refine the request if too much media is returned in response to the initial request, such as by narrowing the time period, or picking particular sub-locations of the building. In some embodiments, users may be limited by a certain area or country when resources are not available.

Continuing in block 320, at the specified interval, the system accesses media information since the last interval to find media at the third-party provider that matches the received user request. The system may directly access social media and other providers of publicly available media via a live search or may access an index of previously crawled media information. The system compares metadata of the media held by each provider to determine media that matches. For example, if the user gives a latitude and longitude point, the system may determine a radius from that point within which to define that a given media item matches. Similarly, if the user gives a specific time, the system may determine a period around this time to define that a given media item matches. The system may also directly receive time ranges and location radius information from the user as part of the query.

Continuing in block 330, the system displays found media to the user. In some embodiments, media may be presented in a trace style, collage, or reel. Once the videos are presented on a map in a trace style, the user would then be able to tap on each provided media bubble to see the timestamp and watch the video(s) grouped to that location. The system may display thumbnails, shorts, or other summaries or previews of the media to reduce the bandwidth of the initial response until the user has drilled down further on specific media items.

Continuing in block 340, the system receives a selection of a specific media item within the found media to display to the user. The user may click on, hover over the specific media item, or provide another indication of a selection. Depending on the type of media, the system may then download a fuller size version of the media, such as downloading the rest of a larger video or replacing a thumbnail preview of an image with a full-size version of the image.

Continuing in block 350, the system receives one or more narrowing criteria that refine the user request to identify less media in response to the user request. The narrowing criteria may reduce the time period, location radius, or other qualities within the found media. In some embodiments, the system can accept positive and negative criteria in the initial request and narrowing criteria. For example, the system may allow the user to specify that particular people are not in the media, that the media is from a particular vantage point or not at other vantage points, and so forth.

Continuing in block 360, the system displays a subset of the displayed found media based on the received narrowing criteria. For example, the system may display a new trace style display, collage, reel, or other list of media. The user can continue this process of narrowing until the user has found the media items the user wants to see. After block 360, these steps conclude.

In some embodiments, the media search system provides a digital map with which the user can zoom in to any location and access media associated with that location. Time may be a further element whereby the user can select ranges to only see media within a particular time range at a particular location. As new media is found, the system can use the digital map to place the media at a certain location and associated with a particular time. A user can scroll to any location on the digital map and access videos using a feature provided on the website or application.

In some embodiments, the user can query the system and its metadata by searching in a geographical field for media that are (or were) broadcasting from that area. The system then finds the existence of such media using metadata and provides access on a map so that the user can access them. The user can query events and search publicly existing media. This can be done on a digital map or via a query field as described here.

Beyond the system grouping videos per the metadata using any method above, users can group videos based on the metadata of similar user-preferences. Furthermore, the videos can be accessed and presented on digital maps to show visually their location.

In some embodiments, users can specifically request to upload and view videos from the system. Users may also provide input as to whether metadata for a particular media item is correct, such as noting that the subject matter of a video is incorrect. In some cases, users may be able to correct metadata for a particular media item. The system may use crowdsourcing or other techniques to figure out the veracity of user claims. For example, once five people move the location of a video to a new location, the system assumes that video's location should be corrected. The video could then be moved automatically or sent to a human reviewer for further review.

In some embodiments, the media search system provides a “wide mode” that enables freeform viewing of videos around a user's area. For example, the user may tap and hold on map and receive social media videos within two hundred feet. This allows users to browse available media without a particular search query in mind. A user might wonder, “what's happening in the park today,” and can use this mode to zoom to that location and find available media.

In some embodiments, the media search system combines information from multiple available sources to provide the features described here. For example, at present, some social media providers like Instagram make it difficult to get all useful media information in one place. One API may be used to find media while another is used to query extended metadata. The system crawls this information and figures out which items should be linked so that all needed information is available in one place to provide the features of the system.

In some embodiments, the media search system provides a plugin architecture that allows new social media or other media providers to enable access to their content to the media search system. The providers themselves, the party that implements the media search system, or open-source contributors may all generate plugins used by the system to provide access to as many media providers as possible.

In some embodiments, the media search system provides a 3D interface in which users are immersed in media (e.g., via a VR headset) and can receive search results in a format that the user is within the search results and can turn or otherwise move to see different angles of an event or access different criteria of the search results. For example, the user may wave left to see earlier videos or right to see later videos once at a location. The user might zoom in a particular area to change the results of found videos to those from another angle of the venue (e.g., zooming from one end of a basketball court to the other to see media from a different perspective).

From the foregoing, it will be appreciated that specific embodiments of the media search system have been described here for purposes of illustration, but that various modifications may be made without deviating from the spirit and scope of the invention.

i/we claim:

1. A computer-implemented method to find media in response to a user search, the method comprising:
receiving a user request to find media that corresponds to a given event, wherein the media is media publicly exposed media captured by people other than the user;
accessing media information to find media that matches the received user request;
displaying found media to the user; and
receiving a selection of a specific media item within the found media to display to the user, wherein the preceding steps are performed by at least one processor.

2. The method of claim 1 wherein the given event is specified by a time period or a location.

3. The method of claim 1 further comprising refining the request by narrowing the time period or picking particular sub-locations of the location.

4. The method of claim 1 wherein accessing media information comprises accessing one or more social media providers that provide publicly available media via a live search API.

5. The method of claim 1 wherein accessing media information comprises comparing metadata of media held by each provider to determine media that matches the user request.

6. The method of claim 1 wherein accessing media information comprises receiving a latitude and longitude that defines a point in the user request, determining a radius from that point within which to define that a given media item matches, and finding media having metadata that specifies a location within the radius.

7. The method of claim 1 wherein accessing media information comprises receiving a specific time from in the user request, determining a period around the specific time within which to define that a given media item matches, and finding media having metadata that specifies a time within the period.

8. The method of claim 1 wherein displaying found media comprises displaying a summary of the found media via a collage of images or a reel of videos.

9. The method of claim 1 wherein receiving the selection of the specific media item comprises receiving an indication that the user clicked on or hovered over the specific media item, downloading a fuller size version of the media, and displaying the fuller size version of the media to the user.

10. The method of claim 1 further comprising receiving one or more narrowing criteria that refine the user request to identify less media in response to the user request, and displaying a subset of the displayed found media based on the received narrowing criteria.

11. A computer system for finding publicly exposed media captured by other people, the system comprising:
a processor and memory configured to execute software instructions embodied within the following components;
a social media component that abstracts differences of social media provider's APIs to allow the system to generically query for available media based on time and location from each social media provider;
a media data store that stores references to discovered media, a time associated with the discovered media, a location associated with the discovered media, and a preview of the discovered media;
a capture component that captures the user's own media from a digital device of the user and stores metadata about the captured media so that the media can be included along with publicly exposed media in future searches for the user;
a mining component that collects and finds potentially relevant media by crawling various social media sites and other sources of publicly available media;
a linking component that forms links between media references that identify media references that share common information;
a query component that receives queries from the user of the system; and
a viewing component that organizes returned media that matches the query and presents the returned media to the user.

12. The system of claim 11 wherein the social media component leverages a plugin architecture that allows more social media providers to be supported by the system over time by writing a plugin specific to a new social media provider.

13. The system of claim 11 wherein the media data store recognizes faces or landmarks in the media to correlate media by this information.

14. The system of claim 11 wherein the capture component detects that a user takes a photo or video with the user's smartphone, receives the photo or video, adds additional metadata including a location and time to associate with the media, and stores that information in the media data store.

15. The system of claim 11 wherein the mining component crawls media by accessing the Internet and other networks to collect media and metadata, generating an index that enables information retrieval along particular axes faster, and stores the index for future searches.

16. The system of claim 11 wherein the mining component also performs live searches upon user request by issuing a query to a social media provider to find media that matches particular criteria when a user request is received.

17. The system of claim 11 wherein the query component builds a query that checks a previously built crawling index for media that matches the user query.

18. The system of claim 11 further comprising an artificial intelligence component that augments the user query with additional search criteria to help find relevant media using pattern matching.

19. The system of claim 11 wherein the viewing component summarizes each media item and generates a summary display to present to the user.

20. A computer-readable storage medium comprising instructions for controlling a computer system to crawl the Internet for publicly exposed media, wherein the instructions, upon execution, cause a processor to perform actions comprising:
receiving a crawl request to access publicly posted videos and stories by providing a specified handle of a third-party provider and a crawl interval at which to crawl for new media;
at the specified interval, accessing media since the last interval at the third-party provider;
grouping the accessed media according to media metadata to create media linking information that links media that occurs at one or more locations and one or more time periods to other media that occurs at the same one or more locations and one or more time periods; and
storing references to the discovered media with the media linking information in a media data store that can be accessed in response to user searches for publicly available media captured by persons other than the user.
